(19) United States
(12) Patent Application Publication
(10) Pub. No.: US 2016/0209833 A1
(43) Pub. Date: Jul. 21, 2016

(54) MANUFACTURING MACHINE AND METHOD OF OPERATION WITH A FUNCTION SELF-CHECK

(71) Applicant: SIEMENS AKTIENGESELLSCHAFT, Munchen (DE)

(72) Inventors: Heinz Distler, Berg Ot Langenthal (DE); Björn Rosenbaum, Erlangen (DE)

(73) Assignee: SIEMENS AKTIENGESELLSCHAFT, Munchen (DE)

(21) Appl. No.: 14/995,889

(22) Filed: Jan. 14, 2016

(30) Foreign Application Priority Data
Jan. 15, 2015 (EP) 15151290.2

(51) Int. Cl. G05B 19/4063; G05B 15/02

(52) U.S. Cl. CPC G05B 19/4063; G05B 15/02; G05B 2219/37616

(57) ABSTRACT

A manufacturing machine and method of operation is disclosed that operates in a more flexible manner is disclosed. The manufacturing machine has an input device for entering manufacturing parameters for manufacturing a workpiece. The manufacturing machine has an analysis device for determining a function demanded of the manufacturing machine using the manufacturing parameters. It also has a test device available to it for testing whether the manufacturing machine has the demanded functionality available to satisfy the demand. A provision device provides a control file for the manufacturing machine for a demanded functionality using predetermined authorization data, when the manufacturing machine does not have the demanded functionality available to it.

### CROSS-REFERENCES TO RELATED APPLICATIONS

This application claims the priority of European Patent Application, Serial No. 15151290.2, filed Jan. 15, 2015, pursuant to 35 U.S.C. 119(a)-(d), the disclosure(s) of which is/are incorporated herein by reference in its entirety as if fully set forth herein.

### BACKGROUND OF THE INVENTION

The present invention relates to a manufacturing machine having an input device for entering manufacturing parameters relating to a workpiece to be manufactured. In addition the present invention relates to a method for operating such a manufacturing machine.

The following discussion of related art is provided to assist the reader in understanding the advantages of the invention, and is not to be construed as an admission that this related art is prior art to this invention.

The term “manufacturing machine” here is to be understood as a machine that carries out a manufacturing or production process by itself or as one that is at least linked into such a process. A typical example of such a manufacturing machine would include a lathe, a machine tool, a milling machine, or the like, that processes workpieces with the aid of one or more tools.

In addition, manufacturing machines can also be machines that merely move in an automated manner. This includes robots that do mechanical work and are controlled by control programs, for example. Likewise a system that represents a network of a number of devices can also be regarded as a manufacturing machine. For example, such a system would also typically be controlled by a control program in order to carry out manufacturing in an automated manner.

The quality, function and performance of manufacturing machines are increasingly determined by their control software. Although software is being newly developed or further developed in ever shorter development cycles currently, machines often cannot derive the extra benefit offered by this software development process.

Many manufacturing machines are what are known as Computerized Numerical Control (CNC) machines. These machines are controlled by a machine program, or a CNC-specific program. These machine programs are generally specific to a particular machine manufacturer.

Industrial workpieces are typically designed with the aid of CAD programs, and CAM systems for computer-aided manufacturing convert the data of a CAD design, into CNC programs that mostly standardized, but there is a need to take into account specific tools, tool speeds, tool design advances, and the like. Thus, as a rule, a postprocessor is still necessary in order to put such a CNC program into the specific form that an actual manufacturing machine needs. However the present invention does not relate to the preparation of work using these CAM systems, but rather to the operation of the manufacturing machine or machine tool itself.

CNC programs are frequently very complex. The individual manufacturing tasks can be realized with different functions of the control software. Therefore some CNC programs contain function calls that must be enabled separately. In addition, the control software can also be upgraded using data media as a transfer medium. This is especially advantageous when older machines are to be provided with new automation software, as part of a so-called “retrofit”.

It would therefore be desirable and advantageous to provide an improved manufacturing machine which obviates prior art shortcomings and can be used in a more flexible manner. A corresponding method for operating such a manufacturing machine is also provided.

### SUMMARY OF THE INVENTION

According to one aspect of the present invention, a manufacturing machine includes an input device for entering manufacturing parameters relating to a workpiece to be manufactured, an analysis device for establishing a demand made on the manufacturing machine by the manufacturing parameters. A test device for determining whether the manufacturing machine has a function available to it to be able to fulfill the demand. A provision device adapted to provide the manufacturing machine with a control file for a function, the control file being provided as a function of predetermined authorization data when the manufacturing machine does not have the function available to it.

According to another aspect of the present invention, a method for operating a manufacturing machine enters manufacturing parameters relating to a workpiece to be manufactured, and makes demands on the manufacturing machine based on those manufacturing parameters. The method checks whether the manufacturing machine has functionality available to it to be able to fulfill the demand, and provides the manufacturing machine with a control file for the functionality as a function of predetermined authorization data, when the manufacturing machine does not have that functionality available to it.

In an advantageous manner the manufacturing machine can thus analyze itself and accordingly establish whether it is sufficiently equipped for the workpiece to be manufactured. In particular the manufacturing machine can itself establish from the manufacturing parameters whether it fulfills one or more demands, which are necessary for manufacturing the workpiece. To do this it must first check which demand is absolutely necessary or which demands are necessary and subsequently whether it has available to it one or more functionalities with which the demand or demands are able to be fulfilled. If it now recognizes by itself that it is missing a functionality needed to fulfill the desired demand, a control file is provided by a provision device, with which this functionality is able to be realized at the manufacturing machine. The file is only provided however if a corresponding authorization is present, i.e. predetermined authorization data is available. Thus the manufacturing machine is equipped on demand and with the corresponding authorization with the necessary functionality or the necessary functionalities.

According to another advantageous feature of the present invention, the provision device can be designed to store the control file for the functionality permanently and to provide said file by enabling it. The provision device integrated into the manufacturing machine thus possesses a memory in which the corresponding control file is permanently stored. A desired function is only enabled however if the corresponding authorization data is present. For example a corresponding authorization code can be purchased from a corresponding machine manufacturer, so that the desired function or a number of functions can be enabled.

As an alternative, the provision device can also be designed to load the control file for the one function from a memory device which is located outside the manufacturing machine, store it temporarily and provide it temporarily. This can be realized for example by the function being loaded from an external data medium or from the Internet onto the manufacturing machine and being provided temporarily, depending on a further criterion. The respective function or the functions are then not permanently available.

According to another advantageous feature of the present invention, the provision device can be designed to provide the control file for a predetermined period of time. Thus, for example the license for a function can be acquired for a period of one month. The respective function is then enabled for the user for the period of one month. To this end they receive a corresponding one-off code or receive daily authorization data for this online for example.

According to another advantageous feature of the present invention, the provision device can be designed to provide the control data for a predefined number of usage cycles. In such a case a usage cycle corresponds for example to the manufacturing of one workpiece. A usage cycle can however also correspond to manufacturing of 100 workpieces or any other given number of workpieces for example. Thus the use of a specific function can be limited to a predetermined number of workpieces or products. A further license can then be acquired for manufacturing further workpieces.

The provision device may also be designed to count a number of usage cycles, which represents how often the control file has been used, as from a predetermined starting point, and then to deactivate the control file when a predetermined maximum number is reached. This enables a control file, including a restricted license, to be downloaded on demand from the Internet for example, and the control file is deactivated automatically after reaching a corresponding maximum number of usage cycles, which are to be understood as above. This deactivation can be carried out for example by the control file being automatically deleted or uninstalled.

According to another advantageous feature of the present invention, the input device can possess a transceiver unit for wirelessly reading out an RFID element. It is thus possible for example for a workpiece which is provided with a RFID chip to transfer its manufacturing parameters automatically to the manufacturing machine.

The test device can have a model of the manufacturing machine. This makes it possible for the manufacturing machine to simulate a manufacturing process before said process is carried out in reality. This enables it to be easily determined whether the manufacturing machine has the corresponding function or the corresponding functions which are necessary for manufacturing a desired workpiece.

The test device can also be embodied for automatically updating the model. This would have the advantage of updates being loaded automatically onto the manufacturing machine as soon as they are available. The manufacturing machine would thus always have the most up-to-date model for the simulation available to it.

### BRIEF DESCRIPTION OF THE DRAWINGS

Other features and advantages of the present invention will be more readily apparent upon reading the following description of currently preferred exemplified embodiments of the invention with reference to the accompanying drawing, in which:

FIG. 1 shows a basic layout of a manufacturing machine in accordance with the present invention; and

FIG. 2 shows a flow diagram of a method in accordance with the present invention.

### DETAILED DESCRIPTION OF THE EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

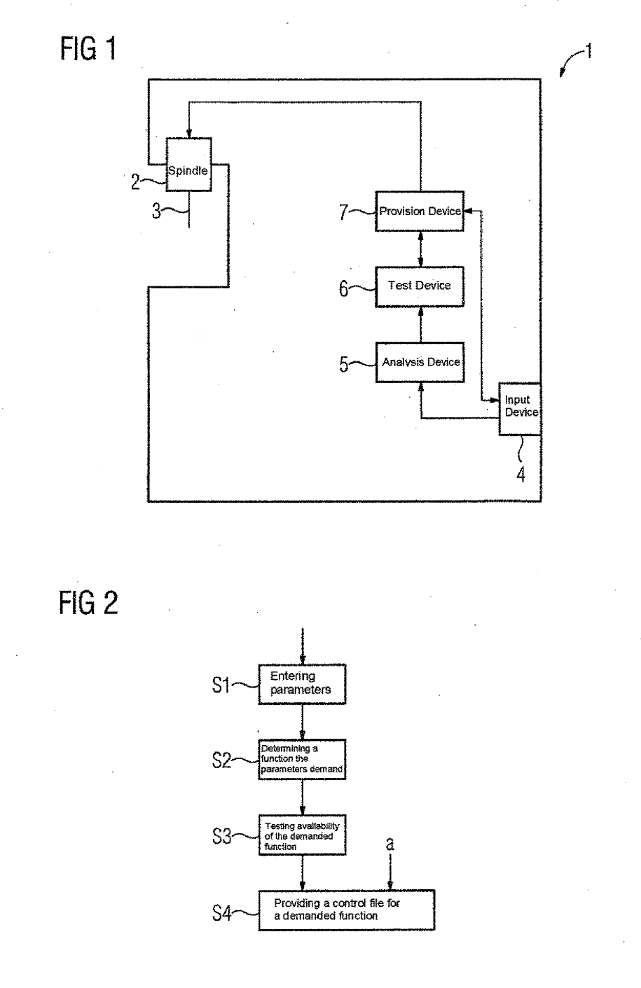

Turning now to the drawing, and in particular to FIG. 1, there is shown a basic layout of a manufacturing machine in accordance with the present invention, generally designated by reference numeral 1 and constructed by way of example in the form of a milling machine. The manufacturing machine 1 includes a spindle 2 with a tool 3. The manufacturing machine 1 may, of course, be constructed as any other machine that manufactures products. It can be a lathe, an injection molding machine, a robot or other machines. Such a manufacturing machine has a data processing device (not shown) that can execute a machine program (CNC program) and can process other data.

In FIG. 1, the manufacturing machine 1 has an input device 4 that enters manufacturing parameters. For example, these parameters can include data from a CAM system that controls the manufacturing machine 1. Thus, the input device 4 can possess an interface with which it can be connected to an external computer, to a data network, or to data medium. The data entered can be already processed, so that it can be used to directly control the manufacturing machine 1. That data is further processed by means of a postprocessor, if necessary.

As an alternative, or in addition, the input device 4 can have a human-machine interface (HMI) available to provide input. With this HMI device, a user can manually enter manufacturing parameters. As an alternative, or in addition, the input device 4 may have a reader unit available to it that automatically reads out manufacturing parameters, from a workpiece for example. This can be implemented by a workpiece being equipped with an RFID chip onto which the manufacturing parameters are loaded, for example. The input device 4 automatically reads out this RFID chip in order to use obtain the manufacturing parameters for controlling the manufacturing machine.

An analysis device 5 of the manufacturing machine 1 is connected to the input device 4. The manufacturing machine can analyze those manufacturing parameters which have been entered automatically or manually via the input device 4, using the analysis device 5. In such cases, the analysis device 5 establishes whether the manufacturing parameters produce one or more specific demands on the manufacturing machine 1. For example the manufacturing parameters may indicate that a particular tolerance is on the surface of the workpiece is demanded. Another type of demand can be a demand of a specific maximum duration of the manufacturing the workpiece. This too can be reflected in the manufacturing parameters.

A test device 6 is connected to the analysis device 5. This test device 6 checks whether a function that is necessary to fulfill the demand that was determined by the analysis device 5 is present in the manufacturing machine 1. The test device 6 may also have to check whether the demand can be fulfilled by functions that are available to the manufacturing machine. Thus, the test device 6 can automatically detect whether a demanded function is available to the manufacturing machine 1.

The manufacturing machine can make use of what is known as a model checker to determine whether a manufacturing machine has a function available to it that satisfies a given demand. By simulation of the implemented functions using a virtual machine model, e.g. a 3D model of the machine and/or of the workpiece, this model checker checks whether the desired workpiece can be created. However, the analysis device 5 and the test device 6 can also carry out a so-called feature check of the implemented strategies. This means that they check whether those demands can be satisfied by the available functions. Functions or “functionalities” can be seen here as processing cycles with which features of the machined workpiece can be milled, e.g. slots, pockets, phases or the like. However functions can also be satisfied by interpolation or compensation strategies, for example. Thus, if a specific surface quality is demanded example (the demand), then under some circumstances this can be provided just by abrasion rather than by milling (demand satisfaction in the processing cycle), and possibly also just by changing interpolation or closed-loop control parameters (interpolation strategy) to satisfy the demand.

As part of the analysis and checking by the devices 5 and 6 there can also be a cross check of standard datasets and versions. In particular there can be a reconciliation with current databases. For functions activated retrospectively it may be determined that the parameterization is not correct and could have been processed with standard settings. As part of the cross check there can then be a notification to the user that the machine cannot fulfill the expected task with the available settings, if the surface is not smooth enough for example. Thus, alternatively, the user can load other functions, or load control data for such other functions into the machine, or activate those functions in the machine.

In order to test whether the manufacturing machine 1 possesses the necessary function or functions, it accesses a provision device 7 in which the control files for those functions are stored. If the test device 6 determines that a function is present in the provision device 7, the provision device 7 will provide the function, the function that drives of the spindle 2 shown in FIG. 1, for example. Advantageously, however, this is dependent on whether a corresponding authorization is available. This corresponding authorization is only available when corresponding authorization data provides the authorization, when a corresponding authorization bit is set, for example. For example, when a user purchases the manufacturing machine with certain functions and by the corresponding authorization bits therefore have already been set by the factory.

Alternatively, the authorization data can comprise an authorization code that is entered into the machine manually or, if necessary, after the delivery of said machine using some other data transmission technology. In this alternative, the authorization is also checked within the machine.

As an alternative the authorization can also be checked outside the manufacturing machine 1, for example by checking for a payment for a software package. Once authorization is determined, the user can download the and load it onto the manufacturing machine 1, by downloading the software from the Internet for example.

With a correspondingly high degree of automation the test device 6, or the provision device 7, can automatically enable a software download that provides a suitable interface, e.g. via the input device 4. This can be done via a cloud service, for example.

To store the received software, either control files or control parameters, the manufacturing machine has memory available to it, in the provision device 7 for example, and preferably has a standard interface, such as Open Architecture interfaces, for integration of the new software. The software can subsequently be separately activated. However such an activation step is not necessarily separate.

Advantageously, the deactivation or deletion of the control files or parameters is also carried out as a function of authorization data. In particular it can be desired that the software is only made available for a specific period of time. In this case the software involved is deactivated or deleted automatically after a certain period of time. A deactivation or deletion can also take place however after a predetermined number of usage cycles, if for example one hundred units (or any other given number) have been manufactured or handled with the manufacturing machine 1.

Referring now to FIG. 2, there is shown a flow diagram of a method in accordance with the present invention. In step S1, manufacturing parameters relating to a workpiece to be manufactured are entered into the manufacturing machine, for example with the input device 4. In a subsequent step S2 a demand on the manufacturing machine 1 is determined using the manufacturing parameters and, as has been explained above, this is done using the analysis device 5. In step S3, whether the manufacturing machine has a function available to it to fulfill the demand is checked. The check is explained in greater detail above in connection with the test device 6. If the manufacturing machine does not have the demanded function available to it, a control file is provided to the manufacturing machine for the demanded function using predetermined authorization data, as shown in step S4. Both steps S3 and S4, and also the authorization data described above are needed by step S4.

For example, in a particular embodiment, a turned part with a high-quality surface is to be manufactured by lathe equipped with standard motors. The torque ripple of standard motors does not satisfy this demand. However there is new software that compensates for this torque ripple. This new software is loaded via a cloud-based service into the machine and that new software is activated in the final working step. Thereafter the new software can be automatically deactivated again and only the use could be charged for.

Thus the invention advantageously makes it possible to use further developments, or new developments did not exist at time that the machine was installed. Likewise an update/upgrade of machines (firmware, embedded software, functions) is possible. However the great advantage of the invention is that the manufacturing machine checks itself as to whether additional or other software is or is not necessary to fulfill the desired demands. This invention can also be used to advantageously be used to support so-called “pay per use” services.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A manufacturing machine, comprising:
an input device that enters manufacturing parameters used to manufacture a workpiece;
an analysis device that determines a function demanded of the manufacturing machine to manufacture a workpiece using the manufacturing parameters;
a test device that determines whether the manufacturing machine has a function available to it that satisfies the demanded function; and
a provision device that provides a control file to the manufacturing machine for the demanded function using predetermined authorization data, when the manufacturing machine does not have a function available to it that satisfies that demand.

2. The manufacturing machine of claim 1, wherein the provision device permanently stores the control file for the demanded function and provides the demanded function by enabling the control file.

3. The manufacturing machine of claim 1, wherein the provision device loads the control file for the demanded function from a storage device that is located outside the manufacturing machine, stores it temporarily and provides it temporarily.

4. The manufacturing machine of claim 3, wherein the provision device provides the control file for a predetermined period of time.

5. The manufacturing machine of claim 3, wherein the provision device provides the control file for a pre-determined number of usage cycles.

6. The manufacturing machine of claim 3, wherein the provision device counts a number of usage cycles from a predetermined starting point that represent how often the control file has been used and deactivates the control file after a predetermined maximum number of usage cycles has been reached.

7. The manufacturing machine of claim 1, wherein the input device has a transceiver unit adapted to wirelessly read an RFID element.

8. The manufacturing machine of claim 1, wherein the test device includes a model of the manufacturing machine.

9. The manufacturing machine of claim 8, wherein the test device automatically updates the model.

10. A method for operating a manufacturing machine, comprising:
entering manufacturing parameters used to manufacture a workpiece;
determining a function demanded of the manufacturing machine using the manufacturing parameters;
testing whether the manufacturing machine has a function available to it that satisfies the demand; and
providing a control file to the manufacturing machine when the manufacturing machine does not have the demanded function available to it using predetermined authorization data, said control file providing a function that satisfies the demand.
